(19) United States
(12) Patent Application Publication
(10) Pub. No.: US 2010/0033695 A1
(43) Pub. Date: Feb. 11, 2010

(54) LITHOGRAPHY APPARATUS AND MANUFACTURING METHOD USING THE SAME

(75) Inventors: Seiichiro KANNO, Iwaki (JP); Tadashi ARAI, Kumagaya (JP); Osamu KAMIMURA, Hino (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/469,838

(22) Filed: May 21, 2009

(30) Foreign Application Priority Data
Aug. 5, 2008 (JP) 2008-201620

(51) Int. Cl. G03B 27/52; G03B 27/54; G03B 27/32

(52) U.S. Cl. 355/30; 355/67; 355/77

(57) ABSTRACT

An lithography apparatus for manufacturing an organic transistor that is capable of aligning accurately in self-alignment fashion relative positions of a gate electrode and a pair of source and drain electrodes and has high productivity. In an lithography apparatus for radiating a light to a photosensitive self-assembled film and exposing the same in self-aligning fashion using a gate electrode as a mask, by transporting a flexible translucent substrate from roller to roller and forming a gate electrode, an insulating layer, and the photosensitive self-assembled film on the flexible substrate when an organic transistor is formed on the flexible substrate, a reflection preventing film is provided on an inner wall of the apparatus that is on the opposite side of the flexible substrate as seen from an exposure light source.

### CLAIM OF PRIORITY

The present application claims priority from Japanese patent application JP 2008-201620 filed on Aug. 5, 2008, the content of which is hereby incorporated by reference into this application.

### FIELD OF THE INVENTION

The present invention relates to an lithography apparatus to be used for a semiconductor device containing organic thin film transistors and method of manufacturing devices using the same.

### BACKGROUND OF THE INVENTION

In recent years, various researches and developments are in progress in display units containing thin film transistors (TFT). Since the TFT is a power-saving and space-saving device, it is beginning to be used as a display unit-driving transistor of mobile appliances such as cellular phones, notebook computers, and PDAs. Most of the TFT is made from inorganic semiconductor materials typified by crystalline silicon and amorphous silicon. This is because the conventional manufacturing process and technique for semiconductor devices can be used for producing the TFT. However, if the semiconductor manufacturing process is used, processing temperatures rise over 350° C. during the forming of semiconductor thin films, thus limiting the substrates to be formed. In particular, flexible substrates such as plastic ones have upper temperature limit of below 350° C. and consequently it is difficult to produce TFTs from inorganic semiconductor materials using the ordinary semiconductor manufacturing process.

To address this problem, research and development of a TFT device using organic semiconductor material (hereinafter referred to as an organic TFT) allowing low-temperature manufacturing is recently under way. For the organic TFT, it is possible to form an organic semiconductor film at low temperatures, forming the film on a substrate with low heat resistance like a plastic substrate is allowed. Accordingly, it is possible to produce unconventional flexible devices.

The method of forming an organic semiconductor film for an organic TFT includes ink jet printing method, the spin-coating method, spray method, transfer method, evaporation method, dipping method, cast method, and the most appropriate method of them is employed depending on the organic semiconductor material. For example, the low-molecular compound like pentacene derivative is formed into a film using the evaporation method or the like and the high-molecular compound like polythiophene derivative is formed into a film from a solvent. As an example of the method of manufacturing semiconductor devices containing organic thin film transistors, there is Japanese Patent Application Laid-Open Publication No. 2007-324201. In this example, the alignment of lower and upper electrodes, which can be a problem in forming an organic TFT using the printing method, is made so that they are self-aligned, and thereby cost reduction and improved performance is achieved.

On the other hand, as an example of the manufacturing apparatus for forming an organic device on a flexible substrate, there is Japanese Patent Application Laid-Open Publication No. 2007-73332. This example discloses a manufacturing apparatus that successively transports the flexible substrates from roller to roller performs the alignment by processing the image of a mark on a flexible substrate that is taken by a CCD camera, and forms an organic material using the printing method.

### SUMMARY OF THE INVENTION

According to the manufacturing apparatus disclosed in Japanese Patent Application Laid-Open Publication No. 2007-73332, the relative alignment of a gate electrode and a pair of source and drain electrodes is done by taking an image of a marker provided in advance on the substrate with a CCD camera and processing the image, and therefore it is necessary to provide the marker in advance or putting the marker during the process, thus increasing the process and the manufacturing cost. Furthermore, a CCD camera is required and the processing of the image taken is also required, causing a problem of increasing the manufacturing cost.

Meanwhile, according to the organic TFT manufacturing method disclosed in Japanese Patent Application Laid-Open Publication No. 2007-324201, since it is possible to align accurately in self-alignment fashion relative positions of a gate electrode and a pair of source and drain electrodes even by the printing technique such as the ink jet method and the transfer method, it is possible to produce high-performance organic thin film transistors in micro-pattern form of about 20 μm at low cost with alignment accuracy of within 1 μm without using a photomask.

However, Japanese Patent Application Laid-Open Publication No. 2007-324201 does not disclose the configuration of a manufacturing apparatus for mass-producing the abovementioned high-performance organic thin film transistor at low cost and in a reproducible fashion. In particular, it does not disclose an lithography apparatus that is important for self-aligning the relative positions of a gate electrode and a pair of source and drain electrodes accurately, which is included in the flexible device manufacturing process.

An object of the present invention is to provide an lithography apparatus to be used for manufacturing organic thin film transistors and with high productivity and capability of self-aligning the relative positions of a gate electrode and a pair of source and drain electrodes accurately.

To achieve the object of the present invention, in an lithography apparatus wherein a flexible substrate with optical transparency is transported from roller to roller; a gate electrode, an insulating layer, and a photosensitive self-assembled film are formed on the flexible substrate when forming an organic transistor on the flexible substrate; and the photosensitive self-assembled film is exposed in self-alignment fashion through the gate electrode as a mask, an antireflection film is formed on the inner wall of the machine on the opposite side of the flexible substrate as seen from a light source for lithograph.

Also, to achieve the object of the present invention, in an lithography apparatus wherein a flexible substrate with optical transparency is transported from roller to roller; a gate electrode, an insulating layer, and a photosensitive self-assembled film are formed on the flexible substrate when forming an organic transistor on the flexible substrate; and the photosensitive self-assembled film is exposed through in self-alignment fashion the gate electrode as a mask, the lithography apparatus includes a solvent tank to hold a solvent for exposing the flexible substrate in the solvent and a mechanism to place the flexible substrate in the solvent, the solvent tank has an opening in the wall where the light source for lithography is disposed, and an antireflection film is formed on the inner wall of the solvent tank on the opposite side of the flexible substrate as seen from the light source for lithograph.

According to the present invention, it is possible to provide a manufacturing apparatus capable of producing with high productivity, high-performance organic thin film transistors having lower and upper electrodes that are precisely aligned within 1 μm by the printing method and face each other through an insulating layer.

### BRIEF DESCRIPTION OF THE DRAWINGS

Embodiments of the present invention will be described in detail based on the following figures, wherein:

FIG. 1 is a diagram showing the entire configuration of a manufacturing apparatus according to an embodiment of the present invention;

FIG. 2 is a cross-sectional view of an lithography apparatus according to a first embodiment of the present invention;

FIG. 3 is a diagram showing the configuration of a second embodiment of the present invention;

FIG. 4A is an enlarged view of an lithography apparatus according to a third embodiment of the present invention;

FIG. 4B is an enlarged view of a solvent tank in the lithography apparatus according to a third embodiment of the present invention;

FIG. 5A is a top view of a transistor to be produced according to an embodiment of the present invention, shown in the order of the manufacturing process, and FIG. 5B is a cross-sectional view of the transistor to be produced according to an embodiment of the present invention, shown in the order of the manufacturing process;

FIG. 6A is a top view of a transistor to be produced according to an embodiment of the present invention, shown in the order of the manufacturing process, and FIG. 6B is a cross-sectional view of the transistor to be produced according to an embodiment of the present invention, shown in the order of the manufacturing process;

FIG. 7A is a top view of a transistor to be produced according to an embodiment of the present invention, shown in the order of the manufacturing process, and FIG. 7B is a cross-sectional view of the transistor to be produced according to an embodiment of the present invention, shown in the order of the manufacturing process;

FIG. 8A is a top view of a transistor to be produced according to an embodiment of the present invention, shown in the order of the manufacturing process, and FIG. 8B is a cross-sectional view of the transistor to be produced according to an embodiment of the present invention, shown in the order of the manufacturing process;

FIG. 9A is a top view of a transistor to be produced according to an embodiment of the present invention, shown in the order of the manufacturing process, and FIG. 9B is a cross-sectional view of the transistor to be produced according to an embodiment of the present invention, shown in the order of the manufacturing process;

FIG. 10A is a top view of a transistor to be produced according to an embodiment of the present invention, shown in the order of the manufacturing process, and FIG. 10B is a cross-sectional view of the transistor to be produced according to an embodiment of the present invention, shown in the order of the manufacturing process;

FIG. 11A is a top view of a transistor to be produced according to an embodiment of the present invention, shown in the order of the manufacturing process, and FIG. 11B a cross-sectional view of the transistor to be produced according to an embodiment of the present invention, shown in the order of the manufacturing process;

FIG. 12A is a top view of a transistor to be produced according to an embodiment of the present invention, shown in the order of the manufacturing process, and FIG. 12B is a cross-sectional view of the transistor to be produced according to an embodiment of the present invention, shown in the order of the manufacturing process; and

FIG. 13 is a diagram showing a process flow of the present invention.

### DETAILED DESCRIPTION OF THE PREFERRED EMBODIMENTS

Prior to detailed descriptions of various embodiments of the present embodiment, the manufacturing process of organic thin film transistors to be produced by the manufacturing apparatus of the present invention is described in detail.

The essential part of the manufacturing process is the process of manufacturing an organic thin film transistor having a channel portion composed of organic semiconductor, an insulating film that is in contact with the channel portion and composed of translucent material, a gate electrode that is in contact with the insulating film and composed of non-translucent material, and a pair of source and drain electrodes separated by the channel portion, and the gate electrode side ends of the pair of source and drain electrodes are set in self-aligning fashion by lithograph from the rear face of the substrate. The channel portion, the insulating film, the gate electrode and the pair of source and drain electrodes are formed by the printing method.

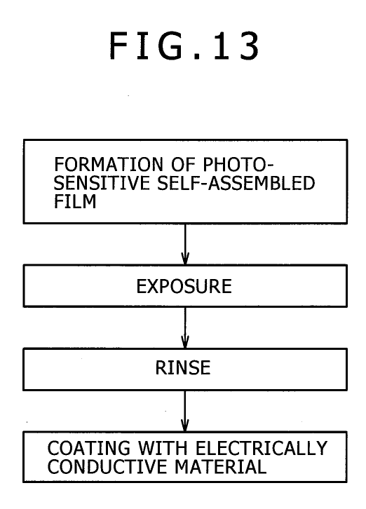

An example of the lithography process for setting the gate electrode side ends of the pair of source and drain electrodes is as follows. That is, this process includes steps of: forming a non-translucent gate electrode (a lower electrode) at the upper portion of a translucent substrate; forming a translucent gate insulating film over at least the gate electrode; coating a photosensitive self-assembled film; exposing from the read face of the translucent substrate; rinsing with organic alkali water solution and then water after the lithography; forming the source and drain electrodes (upper electrodes) by printing conductive material solution on the exposed portion and burning; and forming an organic semiconductor layer for forming a channel portion. Here, the upper electrodes (source and drain electrodes) and the lower electrode (gate electrode) are formed in self-aligning fashion by the process flow shown in (a) through (d) in FIG. 13.

Forming a non-translucent gate electrode, forming the gate insulating film, forming an electrode material layer on the gate insulating film are performed using the printing method. The coating method typically includes ink jet method, micro-dispense method, dip method, spin-coating method, and transfer method. The case of forming a film using the ink jet method is described herein, but the film forming method is not limited to it.

Now, specific materials to be used in the present invention are described. A typical example of the translucent substrate is silicon compound or organic compound. Also, specific examples of the translucent substrate include glass plate, quartz substrate, and flexible resin sheet or so-called plastic film. Plastic films include polyethylene terephthalate, polyethylene naphthalate, polyether imido, polyester sulfone, polyetheretherketone, polyphenylene sulfide, polyacrylate, polyimide, polycarbonate, cellulose triacetate, and cellulose acetate propionate. Since plastic films are flexible, they are advantageous for applications requiring flexible devices.

The conductive material is ink taking a form of nanoparticle, complex, or high molecule and composed of metal, metal oxide, or conductive high-polymer material that can be distributed in solvent to form liquid material.

The translucent insulating film materials can be organic insulating high-polymer materials such as polyimide derivative, benzocyclobutene derivative, photoacrylic derivative, polystyrene derivative, polyvinyl phenol derivative, polyester derivative, polycarbonate derivative, polyvinyl acetate derivative, polyurethane derivative, polysulfone derivative, acrylate resin, acrylic resin, and epoxy resin. Also, insulating materials can be inorganic materials such as silicon oxide, silicon nitride, metal oxide, and metal nitride. Further, the insulating film can be a single layer film or a multi-layer film and can be covered with metal oxide to form photosensitive self-assembled film.

The organic semiconductor material can be polyacene derivative typified by pentacene and rubrene, polythiophene derivative, polyethylene vinyl derivative, polypyrrole derivative, polyisothianaphthene derivative, polyaniline derivative, polyacetylene derivative, polydiacetylene derivative, polyazulene derivative, polypylene derivative, polycarbazole derivative, polyselenophene derivative, polybenzofuran derivative, polyphenylene derivative, polyindole derivative, polypyridazine derivative, metallophthalocyanine derivative, fullerene derivative, and polymer or oligomer in which two or more types of these repeating units are mixed. Also, it may be possible to dope these organic semiconductor materials as required. Further, in order to improve the organic semiconductor transistor performance, the contact surface between organic semiconductor and substrate may be surface-treated by the step before printing on the organic semiconductor. If necessary, these organic semiconductors may be laminated.

The photosensitive self-assembled film material is a compound having a silane coupling agent at its end, and has a substituent which causes a hydroxyl to express when exposed.

The organic alkali solution can be a 2 w % to 25 w % solution, preferably a 2 w % to 5 w % water solution of ammonium hydroxide compound typified by tetramethylammonium hydrooxide and tetrabutylammonium hydrooxide.

A reaction example of the photosensitive self-assembled film material is described for the case of 5-methoxy-2-nitro-benzyl4-(trimethoxysilyl)butanesulfonate. This substance forms couplings on the surface of metal oxide using trimethoxysilyl group. With they being arranged neatly on the surface of a substrate, water contact angle is about 95 degrees. When 350 nm light is irradiated to this substance, the coupling is broken to newly produce a hydroxyl. This changes the water contact angle to about 40 degrees, i.e., improves wet property. Here, if tetramethylammonium hydroxide is used as a rinse agent to dip the substance for one minute and then is washed away with water, water contact angle is improved up to about 20 degrees. Also, unexposed portion remains water contact angle of 95 degrees throughout all treatments. As a solvent of the conductive material, a solvent in which conductive material can be solved is used. For example water or organic solvent including solvents for common photosensitive material such as methyl amyl ketone, ethyl lactate, cyclohexanone, propylene-glycol monomethyl ether, propylene glycol-1, monomethylether-2, and acetate, ether such as diethyle ether, acetone, tetrahydrofuran, and alcohol such as toluene, chloroform, and ethanol can be used. If necessary, mixed solvent of two or more kinds of solvents can be used.

Typical examples of the sensitive self-assembled film forming method include ink jet method, microdispense method, dip method, spin-coating method, and transfer method. This embodiment again uses ink jet method to form the film.

Now, several embodiments of the present invention are described in detail. In these embodiments, since both the positional accuracy and minimum lithography line width of the ink jet printer used were 20 μm, the gate electrode line width was set to 20 μm.

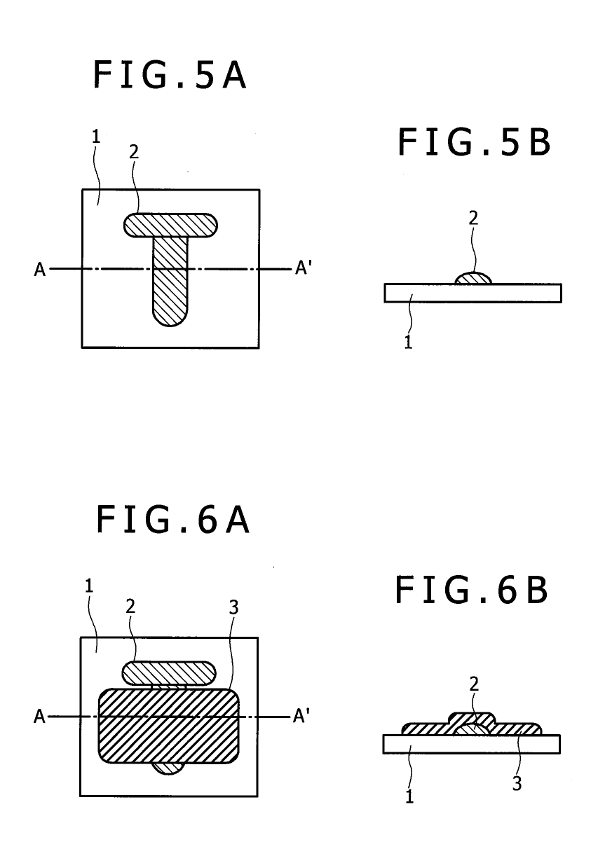

FIGS. 5A and 5B to 12A and 12B are top views and cross-sectional views of the apparatus shown in the order of manufacturing process for forming a source and drain electrodes by lithography from the rear of the substrate. In each figure, “A” shows a top view and “B” is a cross-sectional view taken along the line A-A′.

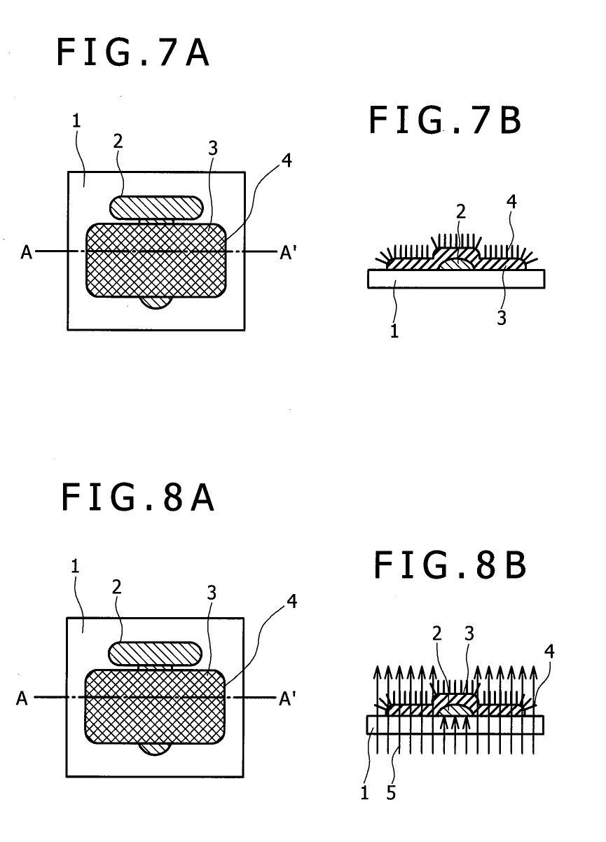

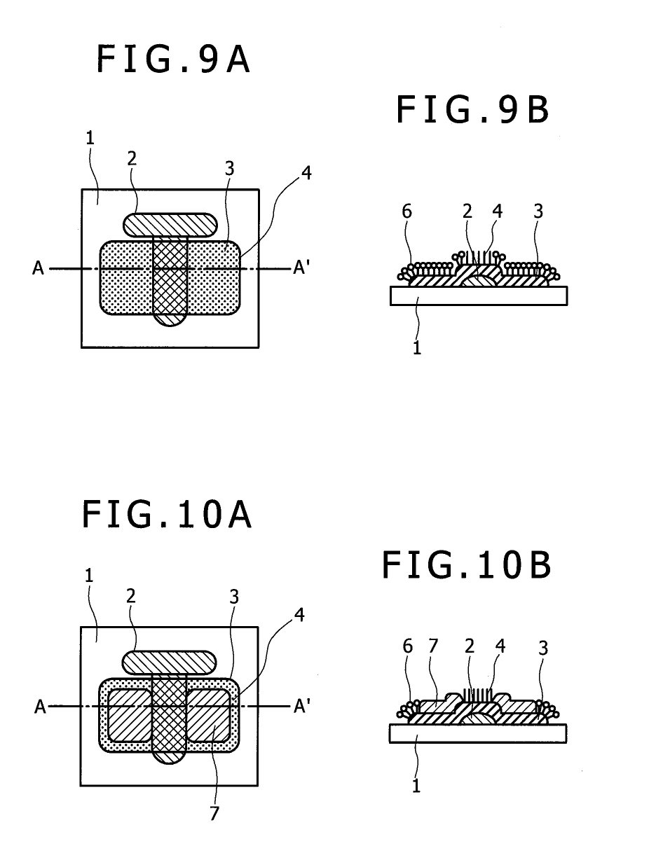

First, organic compound polycarbonate is used as translucent substrate 1 and a gate electrode pattern with line width of 20 μm is printed using gold nano-sized particles distributed in toluene solution as ink by ink jet printing method and is heated at 200° C. for five minutes to form gold gate electrode 2 (top view: FIG. 5A and cross-sectional view: FIG. 5B). The height of the formed gate electrode was about 10 μm. The diameter of the metal core of the gold nano-sized particle is 3.5 nm and the metal core is covered with butanethiolate. Note that gold gate electrode 2 in top view of FIG. 5A is drawn so that it is T-shaped and separated into vertical and horizontal portions. These two portions form the gold gate electrode 2. Therefore, the T-shape may be formed integrally or it may be formed by at least two portions as appropriate. On the other hand, in the case of transfer method for example, it is a good idea to transfer the T-shape integrally. This applies to the top view of each drawing, for example, FIG. 6A, FIG. 7A, FIG. 8A, FIG. 9A, and FIG. 10A and the T-shape is drawn so that it is separated into two portions.

Next, methylisobutylketone solution containing 10 w % of polymethylsilsesquioxane is used to form a gate insulating film by ink jet method and is heat-treated at 150° C. for 20 minutes to form gate insulating film 3 on a required region (top view: FIG. 6A and cross-sectional view: FIG. 6B). The film thickness of gate insulating film 3 was about 100 nm. Also, taking possible misalignment into consideration, the pattern was 20 μm wider than the width of the source and drain electrodes to be formed later. Next, the substrate is dipped in toluene solution containing 0.1 w % of photosensitive self-assembled film material (5-methoxy-2-nitrobenzyl4-(trimethoxysilyl)butanesulfonate), for 10 minutes, rinsed with toluene and dried, and then burned at 110° C. for 10 minutes to form photosensitive self-assembled film 4 on insulating film 3 (top view: FIG. 7A and cross-sectional view: FIG. 7B). The water contact angle of the pre-exposure photosensitive self-assembled film is 95 degrees.

Exposure is performed from the rear of the substrate for 20 minutes using a high-voltage mercury lamp (top view: FIG. 8A and cross-sectional view: FIG. 8B). After lithography, the substrate is dipped in a water solution containing 2 to 3 w % tetramethylammonium hydroxide for one minute, and then rinsed with deionized flowing water for 2 minutes (top view: FIG. 9A and cross-sectional view: FIG. 9B). On completion of this process, the water contact angle of the exposed portion of the self-assembled film is 20 degrees and the unexposed portion remains to be 95 degrees. Source/drain electrode 7 was printed on the exposed portion with the same gold nano-sized particle solution as for gate forming material using ink jet method and then burned at 200° C. for 5 minutes (top view: FIG. 10A and cross-sectional view: FIG. 10B). The film thickness of electrode pattern 7 is about 5 μm. At this point, misalignment between gate electrode and source/drain electrode is about 0.5 μm.

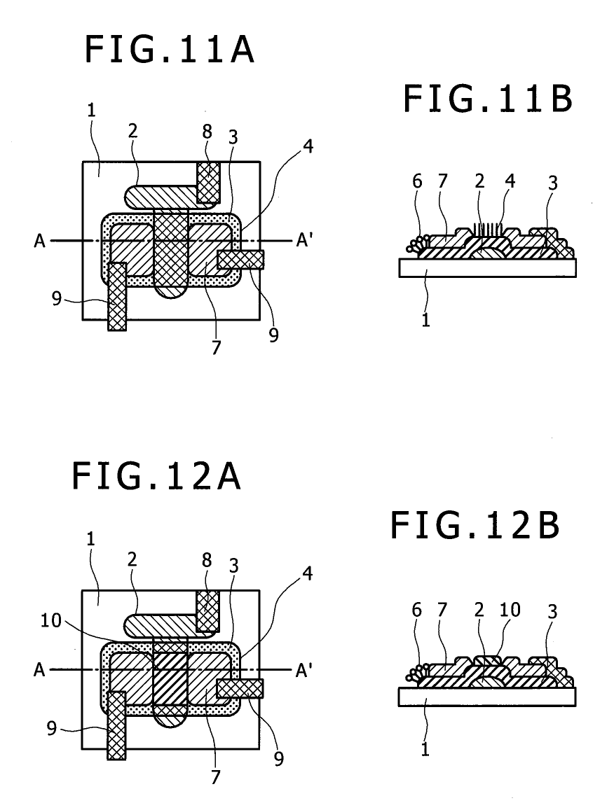

Next, wiring 8 and wiring 9 are printed with the same gold nano-sized particle toluene solution as for the gate electrode using ink jet method, and then burned at 200° C. for 5 minutes (top view: FIG. 11A and cross-sectional view: FIG. 11B). At this time, the film thickness of the wiring is 0.5 μm. Then, channel portion 10 is printed between source electrode 7 and drain electrode 7 immediately above gate electrode 2 with chloroform 5% solution of organic semiconductor, poly(3-hexylthiophene-2,5-diyl) regioregular, using ink jet method, and then heat-treated at 180° C. for 2 minutes (top view: FIG. 12A and cross-sectional view: FIG. 12B). The thickness of channel portion is 5 μm.

The mobility of a transistor to be produced in this process is about 0.085 cm²/Vs. This value is a characteristic of the organic thin film transistor assumed to have no misalignment between upper and lower electrodes.

The insulating film 3 and the organic semiconductor layer 10 can also be formed by spin-coating method. The mobility of an organic thin film transistor formed by spin-coating method is equivalent to that formed by ink jet method. However, the abovementioned printing method uses less solution than in the case of forming by spin-coating method and advantageous. The configuration of a processing apparatus capable of producing an organic transistor using the above process is described in detail below.

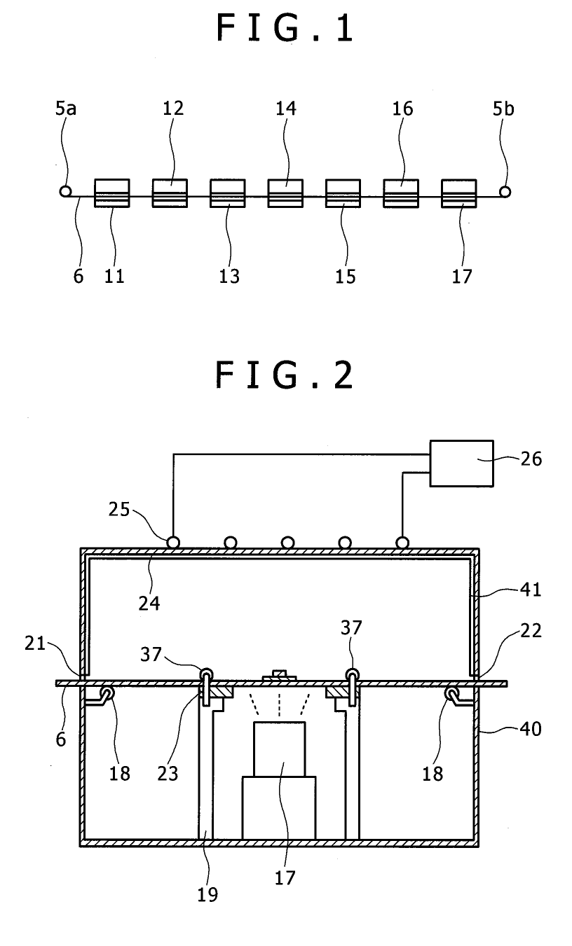

FIG. 1 is a diagram showing the entire configuration of a manufacturing apparatus according to a first embodiment of the present invention. In this embodiment, it is possible to produce continuously on a transparent flexible substrate like plastic sheet a high-performance organic transistor with relative positions of a gate electrode and source/drain electrodes accurately aligned in self-aligning fashion using printing method, and various ideas to reduce manufacturing cost are implemented.

If flexible substrate is handled individually as in the case of a semiconductor wafer, it is deformed due to its lower rigidity and transporting it is not easy. Accordingly, in this embodiment, flexible substrate 6 is rolled up by means of rollers 5a and 5b provided at both ends of the apparatus to move from left to right in the drawing for example for performing each process. Here, 11 is an apparatus for forming a gold gate electrode. In this embodiment, the gate electrode is formed by ink jet method using a toluene solution containing distributed gold nano-sized particles as ink. 12 is an apparatus for forming a gate insulating film. In this embodiment, the gate insulating film is formed by ink jet method using a poly 10% methylisobutylketone solution as ink. 13 is an apparatus for forming photosensitive self-assembled film 4 as shown in FIG. 7B. 14 is an apparatus for burning the formed photosensitive self-assembled film at 110° C. 15 is an lithography apparatus characterizing the present invention. 16 is an apparatus for rinsing with organic alkali solution and rinsing with water. 17 is an apparatus for forming source and drain electrodes, wirings and organic semiconductor devices by ink jet method. In this embodiment, it is possible to produce an organic thin film transistor by transporting a flexible substrate from roller to roller and step by step at each position of the processing apparatus and processing it continuously. The lithography apparatus characterizing the present invention is described below in detail.

FIG. 2 is a cross-sectional view of lithography apparatus 15. Flexible substrate 6 is transported from left to right in drawing by means of external rollers. A substrate can be positioned either by providing the position on flexible rollers in advance or imaging an alignment mark produced during the transportation with a camera and the position to be fixed can be determined based on the image data. This makes it possible to minimize the misalignment of the substrate to be exposed and thereby to position reproducibly. 18 is a substrate guide roller to prevent the flexible substrate from contacting entrance 21 and exit 22 of a chamber. When the substrate moves to an processing position, the substrate is fixed on stage 23 disposed on support table 19. As a fixing method, this embodiment uses four guide rollers fixed on support table 19 and fixes four points outside of the exposure region onto the stage with these rollers. The light source for lithography is high-voltage mercury lamp 17, which is installed inside of support table 19. The inner wall of the support table, where the high-voltage mercury lamp, is installed is coated with black alumite and controlled so that radiation rate becomes 0.9 or more. When light from the high-voltage mercury lamp is radiated from the rear of a transparent substrate, it transmits through other than the gate electrode that serves as a mask. The photosensitive self-assembled film is exposed to this transmitted light. However, if this transmitted light reflects from the inner wall of a chamber and hits the photosensitive self-assembled film on the gate electrode, the photosensitive self-assembled film on the gate electrode is also exposed that is normally should not be exposed. As a result, the gold nano-sized particle solution to be supplied by ink jet to form source and drain electrodes in the next process tends to be easily attached also on the gate electrode, resulting in a decrease in alignment accuracy.

Accordingly, in this embodiment, inner wall 24 is coated with black paint with radiation rate of 0.9 or more in order to prevent the reflection of light from the inner wall of the chamber. This prevents exposure due to reflection of light passing through the substrate and thereby makes it possible to form source and drain electrodes in self-aligning fashion with good alignment accuracy. Although the chamber is heated by the energy of light hitting the inner wall, pipe 25 for circulating cooling water is bonded to the outer wall of the chamber and temperature-controlled cooling water is circulated by an external thermoregulator 26 to prevent temperature increases in this embodiment. Although it is possible to control lithography simply by predetermining lithography duration, it is also possible to measure a contact angle in the printing of source and drain electrodes to be performed after lithography and control the next lithography duration based on the measurement result. This prevents unnecessarily long exposure and insufficient exposure. Although atmosphere in the processing chamber can be air, it is possible to prevent entering of water into the insulating layer formed on the photosensitive self-assembled film or on a layer under it by using nitrogen as atmosphere for example, and also to expect an effect of stabilizing the electrical characteristics of an organic transistor. In addition, the same effect can be expected by increasing air-tightness of the entry and exit of a substrate to lower the pressure of atmosphere in the processing chamber. The atmosphere may be selected as appropriate according to the material of organic transistor to be used.

As described above, since an lithography apparatus configured according to the embodiment of the present invention prevents exposure to the photosensitive self-assembled film on the gate electrode caused by reflected light and realizes self-aligning alignment process, it is possible to produce an organic transistor with high alignment accuracy. Although a high-voltage mercury lamp is employed as light source in this embodiment, the present invention is not necessarily limited to this embodiment, but any light source may be used as long as it is suitable for the photosensitive characteristic of a photosensitive self-assembled film and is applicable to the manufacturing of organic transistors.

Also, in this embodiment, a flexible substrate is fixed by means of four guide rollers, but other means are possible. For example, a flexible substrate may be fixed by a vacuum contact mechanism or electrostatic contact mechanism provided on the stage.

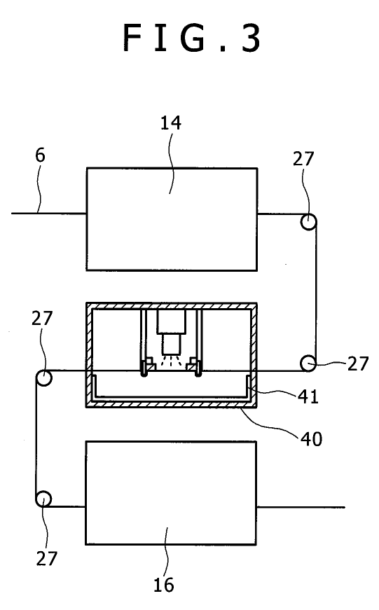

Further, although a light source is disposed under the substrate in this embodiment, other arrangements are possible. For example, it is possible to dispose a light source above the substrate if it is necessary to reverse the substrate with roller 27 for processing, such as when front and back processing apparatuses must be disposed hierarchically for saving space, as shown in the second embodiment (FIG. 3) of the present invention.

It is also possible to expose the substrate from the side by shifting the direction of rolling up the substrate by 90 degrees to feed the substrate upright relative to the lithography apparatus, if reducing the height of the lithography apparatus is desired.

Although a light source is fixed within the processing chamber in this embodiment, other arrangement is possible. For example, it may be disposed on the X-Y stage and may be moved according to processing position. This may make the lithography apparatus more complex but reduces a region to be exposed at a time and requires smaller electricity for radiating light, and thus makes it harder to be affected by reflection of transmitted light.

Although lithography is done with the substrate being fixed in this embodiment, the present invention is not limited to this embodiment. For example, it is possible to perform the lithograph while moving the substrate by installing a light source on a stage that is movable with the movement of the substrate. This configuration allows continuous processing without the need for stopping the movement of the substrate for lithography, and thus improved throughput can be expected.

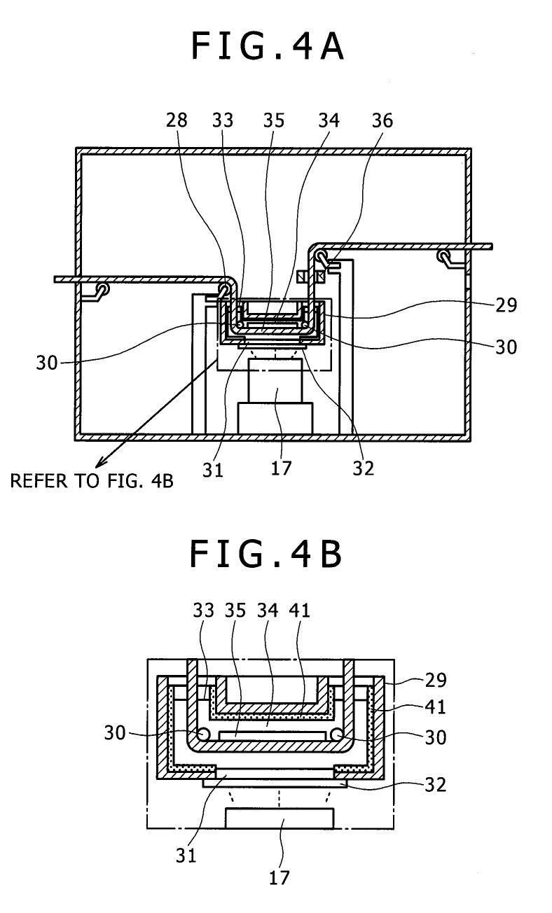

FIG. 4A shows a third embodiment of the present invention. FIG. 4B is an enlarged view of the solvent tank shown in FIG. 4A. This embodiment aims to reduce the period of time required for lithography relative to the first embodiment. The inventors have found that exposure duration can be substantially reduced by molecular diffusion effect when the photosensitive self-assembled film is exposed in the liquid as compared with exposure in the air or reduced-pressure atmosphere, when exposing the photosensitive self-assembled film. Solvent available for this can be organic solvents such as toluene, and xylene, or organic alkali water solutions such as tetramethylammonium hydroxide. Exposure of a substrate in these liquids results in a substantial decrease in exposure duration because reaction is increased by dipping the substrate in the solvent, photosensitivity is increased by variation in reflection factor, rinse effect of the solvent occurs, and the like. Accordingly, in the second embodiment, the organic transistor formed on a flexible substrate is transported from roller to roller into a liquid to expose therein. As in the first embodiment, the flexible substrate is transported from entry and redirected downward by guide roller 28. Solvent tank 29 is provided below the guide roller and is filled with solvent 34 up to a certain level.

It is recommended that fresh solvent should be added and ejected constantly so as to keep a certain level of liquid, in order to prevent variations in lithography condition due to contamination of the solvent. To this end, it is desirable to change the solvent at a predetermined interval, for example, with predetermine number of lot. It is also preferable to control temperature of the solvent to keep the lithography condition for the flexible substrate constant.

The flexible substrate is redirected by the guide roller provided in the coolant tank and is finally ejected from the exit as in the first embodiment. At the bottom of the coolant tank, there is opening 31 for guiding a light from high-voltage mercury lamp 17 installed under the coolant to the coolant tank, the opening being closed by quartz window 32. This configuration allows lithography to the flexible substrate in a liquid, but as in the first embodiment, consideration is given so that light that has been transmitted through the flexible substrate is not be reflected from the inner wall of the coolant tank or liquid surface 33 to expose an undesired region. First of all, the inner wall of the coolant tank is coated with black paint to prevent reflection of light from the inner wall of the coolant tank. Furthermore, to prevent the effect of light reflected from the liquid surface, opening 33 and region-to-be-exposed 35 are made smaller than the surface area of the solvent. The exposed substrate is dried by air blower 36 and then ejected.

As described above, since the lithography apparatus according to the embodiment of the present invention prevents exposure by reflected light in a solvent to the photosensitive self-assembled film on the gate electrode and realizes self-aligning positioning, it is possible to produce an organic transistor with high alignment accuracy with high throughput.

What is claimed is:

1. A lithography apparatus that radiates an exposure light to a photosensitive self-assembled film coated on a translucent substrate when forming a transistor on the substrate, comprising:
a light source for radiating the exposure light;
transport means to support the substrate and move in a predetermined direction; and
a chamber containing at least the light source and the transport means,
wherein: the light source is disposed such that the exposure light transmits through the substrate from another main surface opposite to a main surface of the substrate coated with the photosensitive self-assembled film; and
a reflection preventing film is provided on an inner wall of the chamber that is located opposite to the substrate as seen from the light source and faces the main surface.

2. The lithography apparatus according to claim 1, wherein the reflection preventing film is the inner wall of the chamber that is coated with black alumite.

3. The lithography apparatus according to claim 1, wherein the reflection preventing film is the inner wall of the chamber that is coated with black paint.

4. The lithography apparatus according to claim 1, further comprising:
a pipe for circulating cooling water that is provided on an outer wall of the chamber; and
a temperature regulator for regulating temperature of the cooling water,
wherein temperature increases in the chamber being prevented by the temperature regulator.

5. The lithography apparatus according to claim 1, wherein the transport means has a roll-to-roll mechanism.

6. A lithography apparatus that radiates an exposure light to a photosensitive self-assembled film coated on a translucent substrate when forming a transistor on the substrate, comprising:
a light source for radiating the exposure light;
transport means to support the substrate and move in a predetermined direction;
a solvent tank for holding solvent to be used for exposing the substrate in the solvent;
substrate guiding means for guiding the substrate into the solvent; and
a chamber containing at least the light source, the transport means, the solvent tank, and the substrate guiding means,
wherein: an opening for transmitting the exposure light is provided in a wall of the solvent tank;
the light source is disposed such that the exposure light transmits through the opening, and the exposure light transmits through the substrate from another main surface opposite to a main surface of the substrate coated with the photosensitive self-assembled film; and
a reflection preventing film is provided on the inner wall of the solvent tank that is located opposite to the substrate as seen from the light source and faces at least the main surface.

7. The lithography apparatus according to claim 6, wherein the reflection preventing film is the inner wall of the chamber that is coated with black alumite.

8. The lithography apparatus according to claim 6, wherein the reflection preventing film is the inner wall of the chamber that is coated with black paint.

9. The lithography apparatus according to claim 6, wherein temperature regulation in the solvent tank is performed by means of the temperature regulator.

10. The lithography apparatus according to claim 6, wherein the transport means includes a roll-to-roll mechanism.

11. A device manufacturing method for forming a transistor on a translucent substrate, the method comprising the steps of:
coating a photosensitive self-assembled film on a main surface of the substrate;
radiating an exposure light onto a first region of the substrate where the transistor is to be formed using an lithography apparatus described in claim 1 or 6 from another main surface opposite to the main surface of the substrate; and
measuring water contact angle at a boundary region between a radiation region and a non-radiation region of the photosensitive self-assembled film coated on the substrate, after radiation of the exposure light.

12. The device manufacturing method according to claim 11, wherein a radiation condition for the exposure light to a second region is set on the substrate to be transported next to the first region, based on the measurement result of the contact angle.

13. The device manufacturing method according to claim 11, wherein the transport means of the lithography apparatus is a roll-to-roll mechanism.
